(19) United States
(12) Patent Application Publication
(10) Pub. No.: US 2002/0126063 A1
(43) Pub. Date: Sep. 12, 2002

(54) Rectangular paraboloid truncation wall

(76) Inventor: Peter C. Strickland, Ottawa (CA)

Correspondence Address: Shapiro Cohen, P.O. Box 3440, Station D, Ottawa, ON, K1P 6P1, CA

(21) Appl. No.: 10/085,075

(22) Filed: Mar. 1, 2002

Related U.S. Application Data
(60) Provisional application No. 60/272,471, filed on Mar. 2, 2001.

(51) Int. Cl. H01Q 19/12

(52) U.S. Cl. 343/840

(57) ABSTRACT

A parabolic reflector antenna having a truncated parabolic surface such that the edges of the parabolic reflector form a rectangular side edge configuration. The parabolic reflector antenna is comprised of a truncated parabolic reflector, and at least one truncation wall projecting outwardly from the truncated side edges of the parabolic reflector. In addition, an antenna feed would be located at the focus of the parabolic reflector. As a result, the use of truncation walls does not increase the axial extent of the parabolic reflector. The truncation walls do not extend beyond the outer corners of the parabolic reflector. Furthermore, the additional use of truncation walls does not increase the overall size of the antenna or the size of the radome required to house the antenna. The use of one or more truncation walls advantageously increases or decreases the antenna sidelobe levels on either side of the reflector antenna.

This application relates to U.S. Provisional Patent Application 60/272,471 filed Mar. 2, 2001.

### FIELD OF INVENTION

The present invention relates to the use of parabolic reflectors in an antenna system for use in broadband satellite communications. More specifically, the invention relates to a parabolic reflector with truncated edges utilizing truncation walls along the truncated edges to reduce antenna sidelobe levels.

### BACKGROUND TO THE INVENTION

In the field of satellite communications, antenna systems are required to have a broad bandwidth while having a narrow antenna beam width. The broad bandwidth enables the antenna system to both transmit and receive signals over frequency bands of several GHz. The narrow antenna beam width provides a high gain for signals that are received and transmitted over a particular frequency to and from a particular satellite, and provides discrimination between satellites.

Due to the high speed at which aircraft travel, antenna systems which are mounted on aircraft are required to have a low profile. The low profile minimizes drag. Typically, an antenna system is placed within a radome that has a height restriction in the range of 4 inches to 6 inches depending on the type of aircraft.

Single parabolic reflectors have generally not been ideal for use in applications requiring a low profile antenna. This is due in part to the fact that a parabolic reflector has a low aspect ratio—it is difficult to optimally illuminate the entire reflector surface when the ratio of the aperture width to height is large. In order to illuminate the entire surface of the parabolic reflector, the reflector itself must be distanced from the antenna feed. For example, a parabolic reflector having a surface width of 28 inches would typically require the feed to be placed at least 10 inches from the reflector. This is well beyond the height restriction of the radome on an aircraft. Regardless of whether the feed is axial or offset, the geometry of a single parabolic reflector is less than ideal for use on an aircraft fuselage.

In certain cases a single parabolic reflector with truncated edges (such that the edges form a rectangular or square rim) may have a suitable form factor for use on aircraft or terrestrial platforms. However, a truncated parabolic reflector does have increased spillover from the feed over the edges of the reflector. The spillover is due to the removal of a portion of the parabolic reflector. The truncated surface area, which prior to truncation formed part of a circular cross-section rather than a rectangular cross-section, would have reflected the feed energy which now “spills over”. The spillover energy may be problematic in antenna systems which require very low sidelobe levels. In aircraft satellite communications, minimal spillover is required to avoid interference with other terrestrial antenna systems operating in the same frequency band or with other satellites.

According to known techniques, parabolic reflectors which have circular rims may have an additional cylinder extending axially, in the direction of propagation, from the outer circular rim of the reflector. The axial extent is defined as the extension of the reflector, in the axial direction, from the centre of the parabolic reflector. The cylindrical structure increases significantly the axial extent of the parabolic reflector and consequently is not useful in steered antenna applications.

In order to overcome the aforementioned shortcomings, the present invention seeks to provide a truncated parabolic reflector which utilizes walls located along the truncated edges of the reflector. Furthermore, the present invention seeks to provide a reflector antenna system which advantageously adjusts the antenna sidelobe levels while not increasing the overall size of the antenna system.

### SUMMARY OF THE INVENTION

The present invention seeks to provide a parabolic reflector antenna having a truncated parabolic surface such that the edges of the parabolic reflector has a rectangular front projection. The parabolic reflector antenna is comprised of a truncated parabolic reflector, and at least one wall projecting outwardly from the truncated side edges of the parabolic reflector. These walls are hereinafter referred to as truncation walls. In addition, an antenna feed would be located at the focus of the parabolic reflector. The use of truncation walls does not increase the axial extent of the parabolic reflector. The truncation walls do not extend beyond the outer corners of the parabolic reflector. Furthermore, the additional use of truncation walls does not increase the overall size of the antenna or the size of the radome required to house the antenna. The use of one or more truncation walls advantageously reduces the antenna sidelobe levels on its corresponding side of the reflector antenna.

In a first aspect, the present invention provides a parabolic reflector antenna including:

a parabolic reflector being focussed at a focal point along a parabolic axis, the parabolic reflector having a parabolic surface with four rectangular side edges having a rectangular front projection, the four rectangular side edges forming a rectangular rim; and

at least one truncation wall extending outwardly parallel to the parabolic axis from one of the rectangular side edges.

In a second aspect, the present invention provides a parabolic reflector antenna including:

a parabolic reflector being focussed at a focal point along a parabolic axis, the parabolic reflector having a parabolic surface with four side edges having a square front projection; and

at least one truncation wall extending outwardly parallel to the parabolic axis from one of the square side edges.

### BRIEF DESCRIPTION OF THE DRAWINGS

The present invention will now be described with reference to the drawings, in which:

FIG. 1 is a frontal view of the parabolic reflector with a rectangular rim according to a first embodiment of the present invention;

FIG. 2 is a sectional side view of the parabolic reflector with a rectangular front projection according to a first embodiment of the present invention;

FIG. 3 is a perspective view of the parabolic reflector with truncation walls according to a second embodiment of the present invention; and

FIG. 4 is an isometric view of the parabolic reflector with a square side edge configuration according to a third embodiment of the present invention.

### DETAILED DESCRIPTION

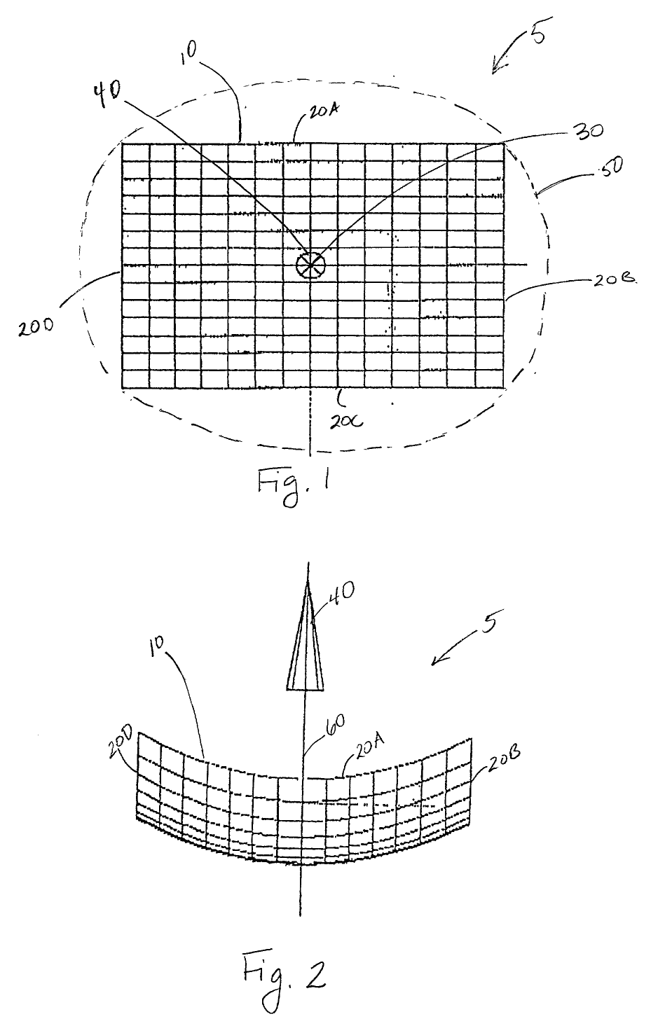

FIG. 1 illustrates a frontal view of an antenna system 5 having a parabolic reflector 10 with truncated edges 20A, 20B, 20C, 20D. The parabolic reflector has a focal point 30 along its parabolic axis. Also shown is an antenna feed 40 focussed toward the focal point 30, along the parabolic axis, of the reflector. The dashed ellipse 50 represents a frontal view of the parabolic reflector 10 had the reflector not been truncated.

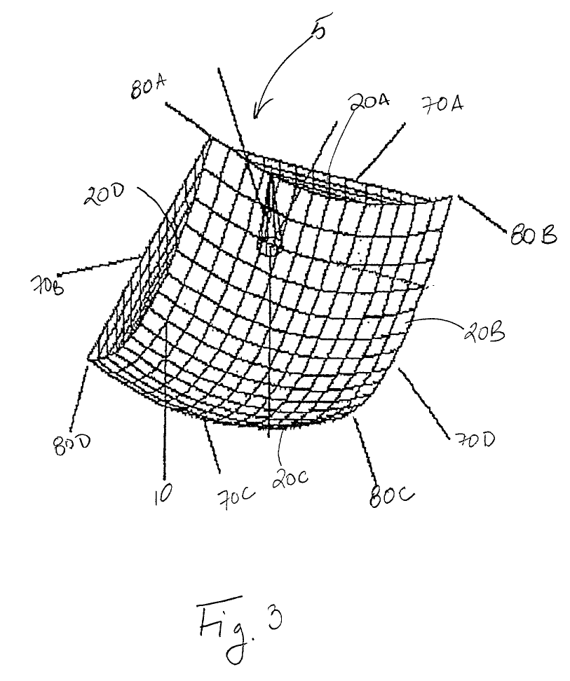

FIG. 2 is a sectional side view of the parabolic reflector 10 of FIG. 1. Three out of the four rectangular side edges 20A, 20B, 20C are shown in this side sectional view. The four rectangular side edges 20A, 20B, 20C, 20D form a rectangular rim around the parabolic reflector 10. The antenna feed 40 is located along the parabolic axis 60. In the case of transmission, the antenna feed 40 is the source of radiation transmitted by the reflector 10. In the case of reception of an antenna signal, the antenna feed 40 acts as a receptor of the radiation received in the reflector 10. The antenna feed provides a transition either from a guided wave on a coaxial cable to an unguided wave propagating through space for transmission or from a unguided wave to a guided wave for reception. The phase centre of the antenna feed is typically focussed toward the focal point of the reflector 10. However, the phase centre of the antenna feed 40 and the focal point of the reflector may be offset in order to introduce an offset in the direction of the main antenna beam.

In one embodiment, the antenna feed 40 may be a waveguide horn structure for excitation of a focus-fed parabolic reflector, or any other antenna element known to the skilled artisan. Regardless of the type of antenna feed chosen, the radiation pattern of the feed is generally designed to illuminate the parabolic surface of the reflector. However, there is usually a compromise between the amount of incident power density directed onto each reflector edge and the resultant spillover at the reflector edges. Accordingly, truncation walls are located along the reflector edges to minimize the spillover while maintaining power density levels.

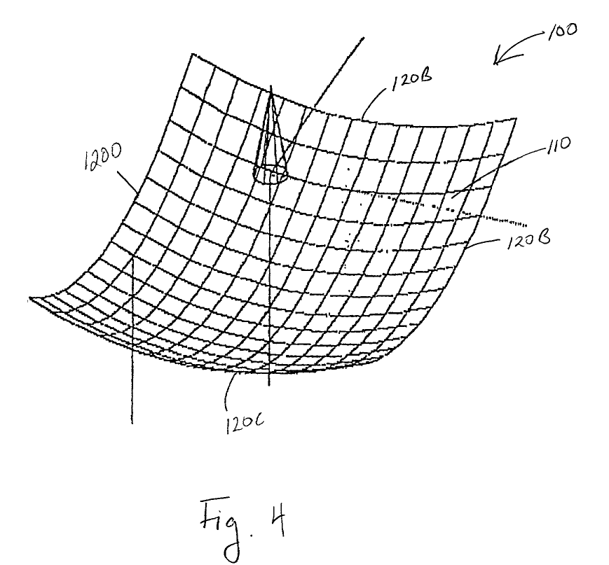

FIG. 3 is a perspective view of an antenna system 5 having a parabolic reflector 10 with truncation walls 70A, 70B, (70C and 70D not shown) according to the present invention. The truncation walls 70A, 70B, 70C, 70D are extensions of the four reflector edges 20A, 20B, 20C, 20D. Located on either side of each truncation wall are the four corners 80A, 80B, 80C, 80D of the reflector 10. These corners 80A, 80B, 80C, 80D are the points of maximum axial projection from the centre point of the parabolic reflector 10.

In FIG. 3, the truncation wall 70A is in fact shorter than the truncation wall 70B. The truncation walls may each vary in size, i.e. length. By varying the length of the truncation walls, the antenna sidelobe characteristics may be adjusted. It is preferred that the length of the truncation walls does not extend beyond the axial extent of the parabolic reflector prior to truncation of its edges. Simply put, the truncation walls should not extend beyond the four corners of the reflector. In FIG. 3, the truncation wall 70B does not have a length greater than the axial extent of two adjacent corners 80A, 80D. Furthermore, although four truncation walls have been utilized the antenna may only require one or two truncation walls on a particular side of the reflector 10.

In one aspect of the present invention, the sidelobe levels of one side of the antenna may be more important than on an opposing side. As such, a truncation wall may extend further on one side than on an opposing side of the reflector 10. Although the truncation walls 80A, 8OB, 80C, 80D are shown to have a linear edge, their shape may vary and in some cases a non-linear edge is required to reduce antenna back-lobe levels. The use of a single truncation wall on a particular side edge will generally increase the peak sidelobe level on the opposing side of the reflector.

In order to counteract an increase in the peak sidelobe level, the truncation walls may use an electromagnetic absorbing material. The use of an electromagnetic absorbing material would reduce the peak sidelobe level on the opposite side from where the material forms an inner lining of the truncation wall. Without the use of electromagnetic material, the electromagnetic energy reflected by the truncation wall is simply reflected to a new location. This new location is often the opposite side of the reflector which increases the sidelobe levels on this side. As such, electromagnetic absorbing material may be used on the inside surface of one or more truncation walls to reduce the sidelobe levels.

FIG. 4 is an isometric view of an antenna system 100 having a parabolic reflector 110 with a square side edge configuration according to the present invention. The parabolic reflector 110 is truncated such that there are four edges 120A, 120B, 120C, 120D provided. Whereas FIG. 3 illustrates rectangular edges, the four edges 120A, 120B, 120C, 120D of FIG. 4 are equal in length and form a square rim. As in FIG. 3, truncation walls (not shown) may be utilized within the antenna system 100 in order to adjust the sidelobe levels.

In an embodiment of the present invention, the antenna system 5 or 100 may be placed in a radome on an aircraft. The advantageous characteristics of the antenna system, such as the size and the sidelobe level adjustment, further enhance its use in antenna satellite communications. The reflector antennas, utilizing truncation walls, of the present invention may be further embodied in an array of contiguously disposed reflector antennas.

What is claimed is:

1. A parabolic reflector antenna including:
a parabolic reflector being focussed at a focal point along a parabolic axis, the parabolic reflector having a parabolic surface with four rectangular side edges having a rectangular front projection, the four rectangular side edges forming a rectangular rim; and
at least one truncation wall extending outwardly parallel to the parabolic axis from one of the rectangular side edges.

2. A parabolic reflector antenna as defined in claim 1, further including an antenna feed with phase centre at the focal point of the parabolic reflector.

3. A parabolic reflector antenna as defined in claim 1, wherein the or each wall has a length less than or equal to a maximum axial extent of the rectangular rim.

4. A parabolic reflector antenna as defined in claim 1, wherein the wall is lined with a material that absorbs electromagnetic energy.

5. A parabolic reflector antenna including:
a parabolic reflector being focussed at a focal point along a parabolic axis, the parabolic reflector having a parabolic surface with four side edges having a square front projection; and
at least one truncation wall extending outwardly parallel to the parabolic axis from one of the square side edges.

6. A parabolic reflector antenna as defined in claim 5, further including an antenna feed with phase centre on the focal point of the parabolic reflector.

7. A parabolic reflector antenna as defined in claim 5, wherein the or each truncation wall has a length less than or equal to a maximum axial extent of the square rim.

8. A parabolic reflector antenna as defined in claim 5, wherein the truncation wall is lined with a material that absorbs electromagnetic energy.
